(19) United States
(12) Patent Application Publication
(10) Pub. No.: US 2015/0256820 A1
(43) Pub. Date: Sep. 10, 2015

(54) SHUTTER GLASS AND CONTROL SYSTEM AND METHOD FOR CONTROLLING THE SAME

(71) Applicant: SHENZHEN CHINA STAR OPTOELECTRONICS TECHNOLOGY CO. LTD., Shenzhen, Guangdong (CN)

(72) Inventors: Yufeng Jin, Shenzhen (CN); Yi-Chien Wen, Shenzhen (CN)

(73) Assignee: Shenzhen China Star Optoelectronics Technology Co., Ltd., Shenzhen, Guangdong (CN)

(21) Appl. No.: 14/241,422

(22) PCT Filed: Jan. 17, 2014
(86) PCT No.: PCT/CN14/70821

§ 371 Date: Feb. 27, 2014

(30) Foreign Application Priority Data
Jul. 23, 2013 (CN) 201310312382.7

(51) Int. Cl. H04N 13/04

(52) U.S. Cl. CPC H04N 13/0438; H04N 13/0454; H04N 13/0497; H04N 2013/0463; H04N 2213/008

(57) ABSTRACT

The present invention provides a shutter glasses and a system and method for controlling the shutter glasses. The system includes: a receiver for receiving a 3D_Enable signal and a STV signal; a timer for timing from the moment when the 3D_Enable signal is in high level, and retiming once the STV signal triggered by a positive source is detected; and a resetter for resetting left and right shutter control signals at the moment when the STV signal is triggered by a positive source if the time started by the timer until the SW signal triggered by a positive source comes is longer than a set time, so that openings of left and right shutters of the shutter glasses synchronize with the left and right image signals. Therefore, a dislocation phenomenon may be effectively eliminated, and thus dizziness and discomfort of a user due to the dislocation phenomenon are reduced.

### FIELD OF THE INVENTION

The present disclosure relates to the technical field of 3D display, and particularly, relates to a shutter glasses and a control system and method for controlling the same.

### BACKGROUND OF THE INVENTION

With rapid development of 3D display technologies and gradual maturity of product lines, the 3D stereographic display technologies have become one focus of development of flat-panel displays. At present, the mainstream 3D display technologies on the market include a chromatic aberration technology, a polarizing technology, a 3D shutter glasses technology and a naked eye 3D technology. In these technologies, the 3D shutter glasses technology is widely accepted by the market due to its advantages of predominant three-dimensional effect, high picture resolution, lower cost of liquid crystal module and the like.

According to the 3D shutter glasses type technology, a frame of image is split into two frames of images corresponding to the left eye and the right eye respectively, and the two frames of images are continuously and alternately displayed on a liquid crystal display screen to synchronously control opening and closing of lenses of a shutter glasses. Thus, both the left and right eyes can see the corresponding images at appropriate time. Finally, the two different images seen by the left and right eyes synthetically form the three-dimensional effect of the original image in the brain.

When a 2D mode is switched to a 3D mode, the 3D shutter glasses may have 50% of error rate, specifically as shown in FIG. 1. For case 1, when the 3D mode is enabled, i.e., at a moment of giving a 3D_Enable pulse signal, a start vertical signal (STV for short) is triggered to be reset. During this reset (about 50 ms), since no STV signals exist, a television (TV) may temporarily has no picture (namely the picture is black), and the Glass continuously displays right eye pictures. After reset is completed, the TV starts displaying left eye pictures, and the Glass also displays left eye pictures. At this moment, the switching is accurate. For case 2, when the 3D mode is enabled, i.e., at a moment of giving a 3D_Enable pulse signal, SW signal is triggered to be reset. During this reset (about 50 ms), no SW signals exist, a TV may temporarily has no picture (namely the picture is black), and the Glass continuously displays left eye pictures. After reset is completed, the TV starts displaying left eye pictures, and the glass displays right eye pictures. At this moment, the switching is dislocated and a crosstalk phenomenon appears.

The above-mentioned two conditions are caused by reasons that the statuses of the Glass are different before reset in case 1 and case 2. The TV could unconditionally start from designated pictures after reset, such as the left eye pictures, however, a control unit (as shown in FIG. 2) for controlling the 3D shutter glasses continuously and alternately sends left and right shutter signals according to the SW signals. That is, the status of the glasses could be continuously changed according to the arrived SW signals. When a user feels the left and right images dislocated, a dislocation phenomenon may be eliminated only by triggering a reset key on the 3D shutter glasses.

Therefore, how to solve the above-mentioned problems so as to eliminate the dislocation phenomenon of the 3D shutter glasses when the 2D mode is switched to the 3D mode and thereby reducing dizziness and discomfort of the user due to the dislocation phenomenon is one of problems dedicated in the industry.

### SUMMARY OF THE INVENTION

One of the technical problems to be solved in the present disclosure is to provide a control system for controlling a shutter glasses, which may effectively eliminate a dislocation phenomenon of the 3D shutter glasses when a 3D mode is enabled and thereby reducing dizziness and discomfort of a user due to the dislocation phenomenon. The present disclosure also relates to a control method for controlling a shutter glasses and the shutter glasses.

To solve the above-mentioned technical problem, the present disclosure provides a system for controlling a shutter glasses, including: a receiver, for receiving a 3D_Enable signal and a SW signal with a set frequency, wherein the SW signal alternately correspond to a left image signal or a right image signal according to the set frequency, and the SW signal is reset when the 3D_Enable signal is in high level; a timer, coupled to the receiver, for timing from the moment when the 3D_Enable signal is in high level, and retiming once the SW signal triggered by a positive source is detected; and a resetter, coupled to the timer, for resetting left and right shutter control signals, if the time counted by the timer until the SW signal triggered by a positive source comes is longer than a set time, at the moment when the SW signal is triggered by a positive source, so that opening of left and right shutters of the shutter glasses synchronizes with the left and right eye image signals.

In an embodiment, the set time is longer than the inverse of the set frequency and shorter than the reset time of the STV signal.

In an embodiment, the set time is in range of 8.3 ms to 50 ms.

In an embodiment, the control system is implemented with an FPGA chip.

According to one aspect of the present disclosure, a shutter glasses including the above-mentioned control system is also provided.

According to another aspect of the present disclosure, a method for controlling the shutter glasses is also provided, including: a receiving step of receiving a 3D_Enable signal and a STV signal with a set frequency, wherein the SW signal alternately correspond to a left eye image signal or a right eye image signal according to the set frequency, and the STV signal is reset when the 3D_Enable signal is in high level; a timing step of timing from the moment when the 3D_Enable signal is in high level, and retiming once the STV signal triggered by a positive source is detected; and a resetting step of resetting left and right shutter control signals at the moment when the STV signal is triggered by a positive source if the time counted by the timer until the SW signal triggered by a positive source comes is longer than a set time, so that opening of left and right shutters of the shutter glasses synchronizes with the left and right eye image signals.

Compared with the prior art, one or more embodiments of the present disclosure may have the following advantages.

According to the present disclosure, a mechanism for detecting 3D enabling signals is added into the system for controlling 3D shutter glasses. The mechanism determines whether the duration from the moment when the 3D enabling signal is detected to be in high level to the moment when the start vertical (SW) signal is triggered by a positive source is longer than a set value. When the duration is longer than the set value, the left and right shutter control signals of the 3D shutter glasses are reset, such that openings of left and right shutters synchronize with the left and right eye image signals. Therefore, a dislocation phenomenon of the 3D shutter glasses may be effectively eliminated, and thus dizziness and discomfort of a user due to the dislocation phenomenon are reduced.

Other features and advantages of the present disclosure will be set forth in the following description, and partially become apparent from the description or may be understood through implementing the present disclosure. The objectives and other advantages of the present disclosure may be realized and obtained through the structures specified in the description, claims, and accompanying drawings.

### BRIEF DESCRIPTION OF THE DRAWINGS

The accompanying drawings are provided for further understanding the present disclosure, constitute a part of the description, and are used for interpreting the present disclosure together with the embodiments of the present disclosure, rather than limiting the present disclosure. In the accompanying drawings:

FIG. 1 is a sequence diagram of accurate switching and dislocation cases of a shutter glasses when a 3D mode is enabled;

FIG. 2 is a block diagram of control unit of a shutter glasses in the prior art;

FIG. 3 is a block diagram of control unit of a shutter glasses according to an embodiment of the present disclosure;

FIG. 4 is a block diagram of a system for controlling the shutter glasses according to an embodiment of the present disclosure;

FIG. 5 is a sequence diagram when the shutter glasses are controlled according to the system of FIG. 4;

FIG. 6 is a flow chart of a method for controlling the shutter glasses according to an embodiment of the present disclosure.

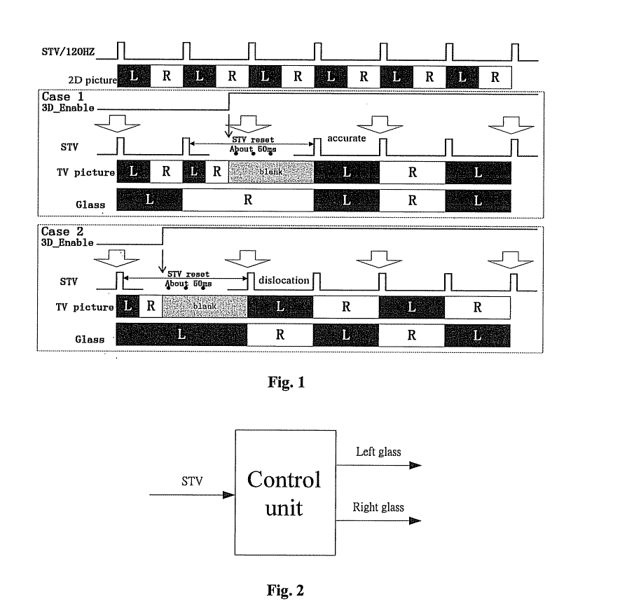

### DETAILED DESCRIPTION OF THE EMBODIMENTS

To make the objectives, technical solutions and advantages of the present disclosure more apparent, the present disclosure will be further discussed in detail below in conjunction with the accompanying drawings.

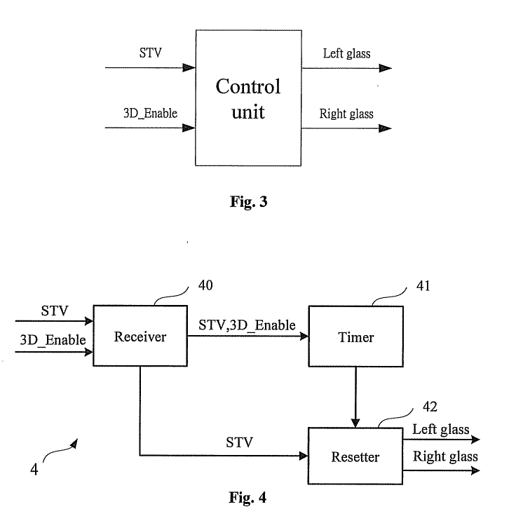

Referring to FIG. 3, which is a block diagram of control unit of a shutter glasses according to an embodiment of the present disclosure.

From FIG. 3, it can be seen that STV signal and 3D_Enable signal are input from the input end of the control unit, and left shutter control signals (left glasses shown in the figure) and right shutter control signals (right shutter shown in the figure) are output from the output end of the control unit.

FIG. 4 shows a system for controlling the shutter glasses according to one embodiment of the present disclosure. Referring to FIG. 4, the system 4 includes a receiver 40, a timer 41, and a resetter 42. The system is preferably implemented with an FPGA chip. The FPGA chip for realizing the above-mentioned functions may be mounted in the frame of the shutter glasses.

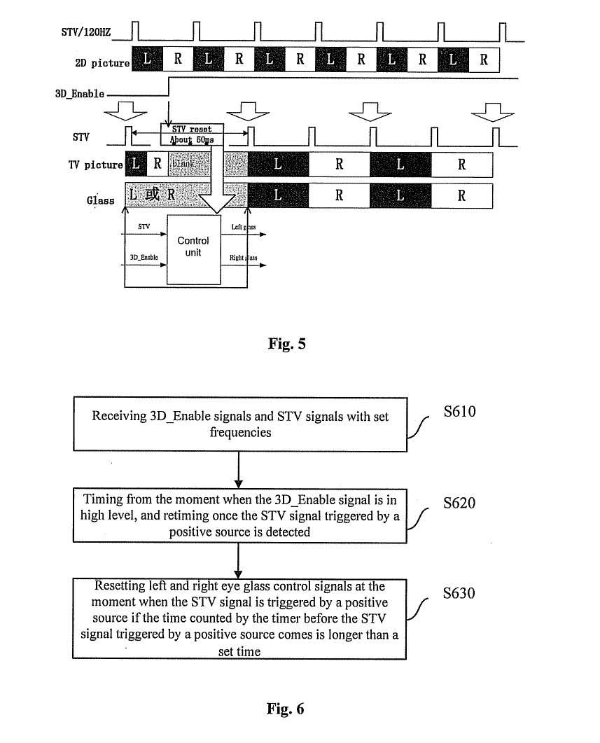

The receiver 40 receives a 3D_Enable signal and a STV signal with a set frequency (such as 120 Hz). As shown in FIG. 5, in a 2D mode, during the time interval of every two adjacent STV (120 Hz) triggered by a positive source, a left eye image signal and a right eye image signal in 2D picture display are correspondingly provided. After the 2D mode is switched to a 3D mode, the SW signal alternately corresponds to a left eye image signal or a right eye image signal based on its set frequency (120 Hz). Moreover, when the 3D mode is enabled, namely when the 3D_Enable signal is in high level, the SW signal enters a reset status. During this reset status, the time for waiting next SW signal is about 50 ms, the time interval of two SW signals is substantially the inverse of the set frequency. In this embodiment, the time interval is 1/120 Hz=8.3 ms. The SW signal under the reset status is a special signal.

The timer 41, being coupled to the receiver 40, is used for timing from the moment when the 3D_Enable signal is in high level, and retiming once the SW signal triggered by a positive source is detected. As shown in FIG. 5, the first time counted by the timer is from the arrow (“↓” in the diagram) corresponding to the high level of the 3D_Enable to the SW signal firstly triggered by a positive source. Because the SW signal at this stage is in a reset status and the reset time of the SW signal is about 50 ms, the first time is regarded as the key of judging whether left and right eye control signals is reset.

The resetter 42 is coupled to the timer 41, and resets the left and right shutter control signals, if the time counted by the timer 41 until a SW signal is triggered by a positive source is longer than a set time, at the moment when the SW signal is triggered by the positive source, so that openings of the left and right shutter of the shutter glasses are synchronized with the left and right eye image signals.

Preferably, the set time is longer than the inverse of the set frequency of the SW signal and shorter than the reset time of the SW signal. In this embodiment, when the set frequency is 120 Hz, the reset time of the SW signal is about 50 ms, and the set time may be longer than 1/120 s (about 8.3 ms) and shorter than 50 ms.

In this embodiment, the set time is 10 ms, and if the duration of the first timing by the timer 41 is more than 10 ms, the STV signal is reset. The moment of the STV signal firstly being triggered by a positive source after the reset, corresponds to a designated image signal (generally a left eye image signal), that is, the TV picture will be started from the designated picture, such as the left eye picture shown in FIG. 5. Then, at this moment, the resetter 42 resets the left and right shutter control signals. That is, no matter the status of the glass (“Glass” shown in the figure) indicates the left shutter control signal or the right shutter control signal, either of these signals will be reset into glasses control signals in accordance with the designated image signal at the moment of the SW signal firstly being triggered by a positive source, such as the left shutter control signal shown in FIG. 5. The TV picture is the left eye picture at this moment, the shutter glasses is controlled by the left shutter control signal, and the left shutter is opened, so that the picture is synchronized with the glasses opening condition. Therefore, a left and right eye dislocation phenomenon occurred after the 3D mode is enabled is eliminated, and thus dizziness and discomfort of a user are avoided.

FIG. 6 is a flow schematic diagram of a control method for controlling the shutter glasses according to one embodiment of the present disclosure, referring to FIGS. 4 and 6 at the same time.

The receiver 40 receives the 3D_Enable signal and the SW signal with a set frequency (S610), the SW signal alternately corresponding to a left eye image signal and a right eye image signal according to the set frequency, wherein when the 3D_Enable signal is of high level, the SW signal enters a reset status.

The timer 41 starts to time from the moment when the 3D_Enable signal is in high level, and retimes once the SW signal triggered by a positive source is detected (S620).

If the time started by the timer 41 until the SW signal triggered by a positive source comes is longer than a set time, then the resetter 42 resets the left and right shutter control signals at the moment when a STV signal is triggered by a positive source (S630), so that openings of the left and right shutter of the shutter glasses are synchronized with the left and right eye image signals.

According to the present disclosure, a mechanism for detecting 3D enabling signals is applied to the system for controlling 3D shutter glasses. The mechanism determines whether the duration from the moment when the 3D enabling signal is in high level to the moment when the start vertical (STV) signal is triggered by a positive source is longer than a set value. The left and right shutter control signals of the 3D shutter glasses are reset when the duration is longer than the set value, so that openings of left and right shutters synchronize with left and right eye image signals. Therefore, dislocation phenomenon of the 3D shutter glasses may be effectively eliminated, and thus dizziness and discomfort of a user due to the dislocation phenomenon are reduced.

Although the foregoing descriptions are preferred specific embodiments of the present disclosure, the protection scope of the present disclosure is not limited thereto. Any variations or alternatives, readily conceivable by peoples familiar with this art within the disclosed technical scope of the present disclosure, shall be incorporated into the protection scope of the present disclosure. Accordingly, the protection scope of the present disclosure should be subjected to the protection scope of the claims.

What is claimed is:

1. A system for controlling a shutter glasses, including:
a receiver, for receiving a 3D_Enable signal and a STV signal with a set frequency, wherein the SW signal alternately correspond to a left eye image signal or a right eye image signal according to the set frequency, and the SW signal is reset when the 3D_Enable signal is in high level;
a timer coupled to the receiver, for timing from the moment when the 3D_Enable signal is in high level, and retiming once the SW signal triggered by a positive source is detected; and
a resetter coupled to the timer, for, if the time started by the timer until the SW signal triggered by a positive source comes is longer than a set time, resetting left and right shutter control signals at the moment when the SW signal is triggered by a positive source, so that openings of left and right shutters of the shutter glasses synchronize with the left and right image signals.

2. The system of claim 1, wherein the set time is longer than the inverse of the set frequency and shorter than the reset time of the SW signal.

3. The system of claim 2, wherein the set time is in range of 8.3 ms to 50 ms.

4. The system of claim 1, wherein the control system is implemented with an FPGA chip.

5. A shutter glasses, including a system for controlling the shutter glasses, the system including:
a receiver, for receiving a 3D_Enable signal and a SW signal with a set frequency, wherein the SW signal alternately correspond to a left eye image signal or a right eye image signal according to the set frequency, and the SW signal is reset when the 3D_Enable signal is in high level;
a timer coupled to the receiver, for timing from the moment when the 3D_Enable signal is in high level, and retiming once the SW signal triggered by a positive source is detected; and
a resetter coupled to the timer, for, if the time started by the timer until the SW signal triggered by a positive source comes is longer than a set time, resetting left and right shutter control signals at the moment when the SW signal is triggered by a positive source, so that openings of left and right shutters of the shutter glasses synchronize with the left and right image signals.

6. The shutter glasses of claim 5, wherein the set time is longer than the inverse of the set frequency and shorter than the reset time of the STV signal.

7. The shutter glasses of claim 6, wherein the set time is in range of 8.3 ms to 50 ms.

8. The shutter glasses of claim 5, wherein the control system is implemented with an FPGA chip.

9. A method for controlling a shutter glasses, including:
a receiving step of receiving a 3D_Enable signal and a SW signal with a set frequency, wherein the SW signal alternately correspond to a left image signal or a right image signal according to the set frequency, and the STV signals is reset when the 3D_Enable signal is in high level;
a timing step of timing from the moment when the 3D_Enable signal is in high level, and retiming once the STV signal triggered by a positive source is detected; and
a resetting step of, if the time counted by the timer until the SW signal triggered by a positive source comes is longer than a set time, resetting left and right shutter control signals at the moment when the STV signal is triggered by a positive source, so that openings of left and right shutters of the shutter glasses synchronize with the left and right image signals.

10. The control method of claim 9, wherein the set time is longer than the inverse of the set frequency and shorter than the reset time of the SW signal.

11. The control method of claim 10, wherein the set time is in range of 8.3 ms to 50 ms.
